(19) United States
(12) Patent Application Publication
(10) Pub. No.: US 2008/0287425 A1
(43) Pub. Date: Nov. 20, 2008

(54) Method for Controlling Chinch Bugs

(75) Inventors: Kim Watson, Cherry Hill, NJ (US); Robert Herrick, Hamilton, NJ (US)

Correspondence Address: PATENT ADMINISTRATOR;FMC CORPORATION, 1735 MARKET STREET, PHILADELPHIA, PA, 19103, US

(73) Assignee: FMC CORPORATION, Philadelphia, PA (US)

(21) Appl. No.: 11/815,729

(22) PCT Filed: Feb. 9, 2006
(86) PCT No.: PCT/US2006/006964

§ 371 Date: Jul. 17, 2008

Related U.S. Application Data
(60) Provisional application No. 60/651,181, filed on Feb. 9, 2005.

(51) Int. Cl. A01N 33/26; A01N 43/40; A01N 43/78; A01N 43/08; A01N 43/88; A01P 7/04

(52) U.S. Cl. 514/229.2; 514/610; 514/341; 514/365; 514/471

(57) ABSTRACT

The present invention relates to a method for controlling chinch bugs comprising introducing to a locus where chinch bug control is needed or expected to be needed a composition comprising a nitroguanidine insecticide.

This application claims the benefit of U.S. Provisional Application No. 60/651,181, filed Feb. 9, 2005.

### FIELD OF THE INVENTION

The present invention relates to the field of controlling chinch bugs.

### BACKGROUND OF THE INVENTION

Adult chinch bugs are about one-fifth of an inch long with black and white wings folded over their backs. A chinch bug causes damage to grasses by inserting its slender beak into the grass and sucking the plant juices. As the chinch bug sucks the plant juices, it releases a toxin that causes yellowish to brownish patches in the grasses. Typical injury to turf appears as spreading patches of brown, dead grass.

Chinch bugs are most damaging to St. Augustine grass. They also appear on grasses such as zoysia, Bermuda, and centipede, but infestations usually occur where high populations have built up on St. Augustine grass.

Chinch bugs have become resistant to almost every pesticide used to control them. They were even resistant to DDT in the early 1950s. Synthetic pyrethroids are currently the best means of controlling chinch bugs.

It would be advantageous to provide a new method for controlling chinch bugs.

### SUMMARY OF THE INVENTION

It has been unexpectedly found that a new class of insecticides, nitroguanidines (a subclass of neonicotinoids), are useful in controlling chinch bugs and chinch bugs developing resistance to synthetic pyrethroids. Specifically, the present invention relates to a method for controlling chinch bugs comprising introducing to a locus where chinch bug control is needed or expected to be needed a composition comprising a nitroguanidine insecticide. Other aspects of the present invention will also be apparent.

### DETAILED DESCRIPTION OF THE INVENTION

The present invention relates to a method for controlling chinch bugs comprising introducing to a locus where chinch bug control is needed or expected to be needed a composition comprising a nitroguanidine insecticide. Another embodiment of the present invention is a method for controlling chinch bugs previously treated with a synthetic pyrethroid, said method comprising introducing to a locus where chinch bug control is needed or expected to be needed a composition comprising a nitroguanidine insecticide. The introduction of the nitroguanidine insecticide can be done at alternating times with synthetic pyrethroids or introduction of the nitroguanidine insecticide can be done in combination with synethetic pyrethroids. The nitroguanidine insecticide is preferably selected from clothianidin, dinotefuran, imidacloprid and thiamethoxam. Most preferably, the nitroguanidine insecticide is dinotefuran.

The locus can be a chinch bug-infested area, a location that is expected to be chinch bug-infested, a location adjacent to a chinch bug-infested area or a location adjacent to an area that is expected to be chinch bug-infested.

The compositions of the present invention may be derived from commercially available formulations of the nitroguanidine insecticides. For example, dinotefuran, sold by Valent under the name and trademark of Safari 20 SG, finds utility in the present invention. Using methods known to one skilled in the art, the above-mentioned formulations of insecticides can be dispersed in an aqueous medium to provide a composition useful in this invention.

As used in this specification the term “nitroguanidine” refers to a subclass of neonicotinoids represented by the general backbone structure of formula A:

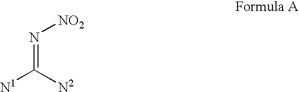

where the 1 and 2 position nitrogens (N¹ and N²) are substituted, for example as in clothianidin, dinotefuran, imidacloprid and thiamethoxam. The term “clothianidin” means (E)-1-(2-chloro-1,3-thiazol-5-ylmethyl)-3-methyl-2-nitroguanidine, CAS Registry Number 210880-92-5 (formerly 205510-53-8), and is represented by the following formula:

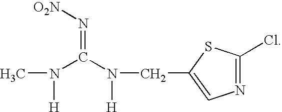

The term “dinotefuran” means (EZ)-(RS-1-methyl-2-nitro-3-(tetrahydro-3-furylmethyl)guanidine, CAS Registry Number 165252-70-0, and is represented by the following formula:

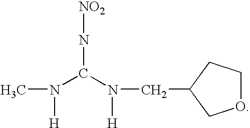

The term “imidacloprid” means (EZ)-1-(6-chloro-3-pyridylmethyl)-N-nitroimidazolidin-2-ylideneamine, CAS Registry Number 138261-41-3, and is represented by the following formula:

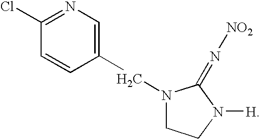

The term “thiamethoxam” means (EZ)-3-(2-chloro-1,3-thiazol-5-ylmethyl)-5-methyl-1,3,5-oxadiazinan-4-ylidene(nitro)amine, CAS Registry Number 153719-23-4, and is represented by the following formula:

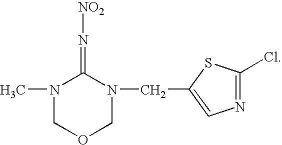

The term “locus” refers to any location where control of chinch bugs is needed or is expected to be needed. Such locations may include, without limitation, golf courses, lawns and locations adjacent to buildings, trees, posts poles, fences, as well as other locations.

The following examples further illustrate the present invention, but, of course, should not be construed as in any way limiting its scope. The examples set forth certain data demonstrating synthetic pyrethroid chinch bug resistance and various treatment insecticides' efficacy on chinch bugs. Unless otherwise indicated in the examples, ‘Safari’ refers to a formulation of dinotefuran containing 20% by weight active ingredient available from Valent USA Corporation in Walnut Creek, Calif.; ‘TalstarOne’ refers to a formulation of bifenthrin containing 7.9% by weight active ingredient available from FMC Corporation in Philadelphia, Pa.; ‘DeltaGard TC’ refers to a formulation of deltamethrin containing 4.75% by weight active ingredient available from Bayer Environmental Science in Research Triangle PK, NC; and ‘Demon TC’ refers to a formulation of cypermethrin containing 25.3% by weight active ingredient available from Syngenta in Greensboro, N.C.

### EXAMPLE 1

Chinch Bug Mortality from Treatments of Insecticides Southern chinch bugs (Blissus insularis) were collected from infested St. Augustine grass lawns in Alachua Co., FLa. Chinch bugs from these collection areas were considered susceptible to insecticides; no insecticide resistance had been reported from these sites. “Resistant” chinch bugs were collected from several sites in South Daytona, Fla., where applicators had difficulty controlling chinch bug populations. Chinch bug adults were placed into plastic vials (2.5×10.2 mm) containing a cone-shaped, moistened 70 mm Whatman filter paper at the bottom, one untreated ‘Palmetto’ St. Augustine grass sprig (about 5.0- 6.4 cm long, with three leaflets and one node), and a foam cap. Chinch bugs were allowed to acclimate in the vials for about 24 to 48 hours in the laboratory.

Next, 20 susceptible or resistant chinch bugs were then placed in the center of 6-inch diameter pots of ‘Palmetto’ St. Augustine grass, a mesh cage was placed over the pots, and the chinch bugs were allowed to acclimate for about 20 hours.

Liquid treatments to the pots were applied using a 4-nozzle, 2-meter boom (ca. 6 ½ ft boom, at 15.25″ nozzle spacing) connected to a 32 psi CO₂ backpack sprayer. The treatments of insecticides were diluted to a 1 liter volume, and a 6-second spray occurred in each pot. The weather at application: slightly cloudy; wind speed <2 mph; soil temp (4 inch depth): 68° F.; air temperature: 78° F.; relative humidity: 74%.

There were two untreated controls, one containing “susceptible” and the other with “resistant” chinch bugs.

The number of live and dead chinch bugs was determined 7 days after treatment (DAT). Data were converted to percentages. Results are in Table 1.

TABLE 1
Chinch bug mortality 7 days after exposure to treated pots
of St. Augustine grass.

| | | Rate | | |
|---|---|---|---|---|
| | | (amt. | Rate | |
| Chinch bug | | product/ | (grams AI/ | % Mortality |
| population | Treatment | 1000 ft²) | 1000 ft²) | (7 DAT) |
| Susceptible | Safari | 28.1 grams | 5.62 | 89 |
| Susceptible | DeltaGard SC | 17.7 ml | 0.89 | 85 |
| Susceptible | TalstarOne | 7.4 ml | 0.58 | 100 |
| Susceptible | Demon TC | 9.8 ml | 2.43 | 75 |
| Susceptible | Untreated | — | — | 30 |
| “Resistant” | Safari | 28.1 grams | 5.62 | 90 |
| “Resistant” | DeltaGard SC | 17.7 ml | 0.89 | 65 |
| “Resistant” | TalstarOne | 7.4 ml | 0.58 | 92 |
| “Resistant” | Demon TC | 9.8 ml | 2.43 | 34 |
| “Resistant” | Untreated | — | — | 26 |

### EXAMPLE 2

Developing Chinch Bug Resistance to Bifenthrin (Synthetic Pyrethroid) Serial dilutions of bifenthrin were made from Talstar Flowable 7.9% AI (FMC, Philadelphia, Pa.). Freshly harvested St. Augustine grass stolons (about 10 cm long) were dipped into the dilutions and allowed to air dry. The stolons were placed individually into Petri dishes (15 cm diameter) containing moist filter paper to maintain high humidity. Twenty adult southern chinch bugs were placed into each Petri dish and held for about 24 hours at about 28° C. Sample sizes of adults tested ranged from 200 (20 each at 10 dose levels) to 480 (20 each at 24 dose levels) for each location to estimate LC-50 for that location. Different numbers of adults tested per location depended on availability of adults plus variability noted in testing. Since the objective of this study was to estimate LC-50 values, doses expected to give 25 to 75% mortality for best LC-50 were used. Mortality was defined as virtually no movement by an adult during a 5 minute observation period through a 5× large magnifying lens. The no movement criterion was used to avoid ambiguities of comatose, unable to stand, moribund, etc. Results are in Table 2.

TABLE 2
LC-50 Measurement of Various Chinch Bug Populations
to Demonstrate Growing Resistance

| Location - | Control | | |
|---|---|---|---|
| Source of | Problem in | Adults | LC-50 |
| Chinch Bug | the field? | Tested | (ppm) |
| Clermont | Yes | 200 | 78.7 |
| Daytona Beach | Yes | 220 | 243.3 |
| Key Largo | Yes | 480 | 148.2 |
| Ormond Beach | Yes | 220 | 698.8 |
| Palm Coast | Yes | 240 | 1,693 |
| Palmetto | Yes | 320 | 493.6 |
| Sarasota | Yes | 220 | 89.2 |
| Spring Hill | Yes | 240 | 159.3 |
| Belle Glade | No | 300 | 2.6 |
| Gainesville | No | 200 | 10.6 |
| Fort Pierce | No | 240 | 2.8 |
| Kendall Lakes | No | 240 | 9.3 |
| Lithia | No | 240 | 5.4 |
| Orlando | No | 220 | 2.3 |
| Royal Palm | No | 200 | 7.3 |
| Beach | | | |
| Tamarac | No | 220 | 9.7 |

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method for controlling chinch bugs comprising introducing to a locus where chinch bug control is needed or expected to be needed a composition comprising a nitroguanidine insecticide.

2. The method of claim 1, wherein the nitroguanidine insecticide is selected from the group consisting of clothianidin, dinotefuran, imidacloprid and thiamethoxam.

3. The method of claim 2, wherein the nitroguanidine insecticide is dinoteflran.

4. A method for controlling chinch bugs previously treated with a synthetic pyrethroid, said method comprising introducing to a locus where chinch bug control is needed or expected to be needed a composition comprising a nitroguanidine insecticide.

5. The method of claim 4, wherein the nitroguanidine insecticide is selected from the group consisting of clothianidin, dinotefuran, imidacloprid and thiamethoxam.

6. The method of claim 5, wherein the nitroguanidine insecticide is dinotefuran.

7. The method of claim 4, wherein said introducing of the nitroguanidine insecticide is done at alternating times with the synthetic pyrethroid.

8. The method of claim 4, wherein said introducing of the nitroguanidine insecticide is done in combination with the synthetic pyrethroid.

9. The method according to claim 1, wherein said locus is a chinch bug-infested area, a location that is expected to be chinch bug-infested, a location adjacent to a chinch bug-infested area or a location adjacent to an area that is expected to be chinch bug-infested.

10. The method according to claim 4, wherein said locus is a chinch bug-infested area, a location that is expected to be chinch bug-infested, a location adjacent to a chinch bug-infested area or a location adjacent to an area that is expected to be chinch bug-infested.
